(19) United States
(12) Patent Application Publication
(10) Pub. No.: US 2015/0257060 A1
(43) Pub. Date: Sep. 10, 2015

(54) BASE STATION APPARATUS

(71) Applicant: SHARP KABUSHIKI KAISHA, Osaka-shi, Osaka (JP)

(72) Inventors: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/440,257

(22) PCT Filed: Oct. 31, 2013
(86) PCT No.: PCT/JP2013/079628

§ 371 Date: May 1, 2015

(30) Foreign Application Priority Data
Nov. 2, 2012 (JP) 2012-242347

(51) Int. Cl. H04W 36/00

(52) U.S. Cl. CPC H04W 36/0083; H04W 84/045

(57) ABSTRACT

There has been a problem that overhead increased from a time when a macro base station apparatus transmits, to a mobile station apparatus, an instruction of connection to small cell to a time when a pico base station apparatus performs scheduling of the mobile station apparatus. A first base station apparatus that constitutes a first cell for transmitting control information to a mobile station apparatus, in which a second cell, that is constituted by a second base station apparatus exists in the first cell, the control information with which the first base station apparatus gives an instruction of transmission of a reference signal to the mobile station apparatus in the first cell includes therein information for designating to transmit the reference signal to either the first base station apparatus or the second base station apparatus and information of a transmission parameter that is used for transmission of the reference signal to a base station apparatus that is instructed in the control information, and the first base station apparatus notifies the mobile station apparatus of the control information.

### TECHNICAL FIELD

The present invention relates to a base station apparatus.

### BACKGROUND ART

Standardization of the long term evolution (LTE) system that is the 3.9G cellular telephone radio communication system is completed, and standardization is being performed currently in the LTE-Advanced (LTE-A, also referred to as IMT-A or the like) system which is evolved from the LTE system.

In uplink (transmission from a mobile station apparatus To a base station apparatus) of the LTE system (LTE in order to grasp channel information which is used when the base station apparatus assigns radio resources to the mobile station. apparatus, the mobile station transmits a sounding reference signal (SRS) to the base station. The mobile station apparatus is notified of parameters (also referred to as a parameter set) used for SRS transmission by radio resource control (RRC) signaling and performs transmission based on the parameter set. The mobile station apparatus in the LTE system supports Periodic-SRS (P-SRS) of the SRS transmitted at a certain interval.

In the LTE-A system (LTE Rel. 10), it is desired that, in addition to supporting multi-antenna transmission in the uplink, one have station accommodates more users compared to the LTE. In the P-SRS for transmission at a certain interval in the LTE, transmission is only performed periodically with a specific transmission rule which is designated in an RRC layer, so that there is no support for multi-antenna nor flexibility of scheduling which is desirable for accommodating many users. Therefore, introduced in the LTE-A system is Aperiodic-SRS (A-SRS) in which it is possible that a terminal device is triggered only when sounding of the uplink is desired and the SRS is transmitted by using only desired radio resources when desired. For the trigger of the A-SRS, a transmission timing is determined based on transmission instruction information added to downlink control information (DCI) which is a control signal of a physical layer. The transmission instruction information of the A-SRS exists by 1 bit in DCI formats 0, 1A, 2B and 2C, and exists by 2 bits in a DCI format 4. The parameter set used for transmission of the A-SRS is also notified by RRC signaling, and different parameter sets may be prepared between a case where the transmission instruction is given with the DCI format 0 and a case where the transmission instruction is given with the DCI formats 1A, 2B or 2C. Further, since 2 bits exist in the DCI format 4, four patterns may be indicated, including a case where the A-SRS is not transmitted and cases where the transmission instruction of the A-SRS is given with three different parameter sets. Therefore, the mobile station apparatus is able to have five different parameter sets at maximum. These parameter sets include information of a rotation amount of cyclic shift, a position of Comb of IFDM, the number of antenna ports, an SRS transmission bandwidth, and a frequency position (refer to NPL 1).

On the other hand, in Rel. 12, it is being considered that a small cell constituted by a pico base station apparatus is constituted in a macro cell constituted by a macro base station apparatus (base station apparatus having a wide coverage), and a specific mobile station apparatus is instructed to be connected with the pico base station apparatus according to the number of mobile station apparatuses connected with the macro base station apparatus for performing data transmission. By giving the instruction of connection with the pico base station apparatus, the macro base station apparatus is able to offload data transmission to the pico base station apparatus, and improvement of throughput of the entire cell becomes possible.

### CITATION LIST

### Non Patent Literature

NPL 1: 3GPP TS 36.331 V10.4.0

### SUMMARY OF INVENTION

### Technical Problem

When the macro base station apparatus gives an instruction of connection with the small cell to the mobile station apparatus, the pico base station apparatus is desired to receive the P-SRS or the A-SRS transmitted by the mobile station apparatus and know channel information used for scheduling and reception quality for link adaptation. When the macro base station apparatus and the pico base station apparatus have different cell IDs, however, the pico base station apparatus have to notify the mobile station apparatus of the parameter sets of the P-SRS and the A-SRS by RRC signaling after giving the instruction of connection with the small cell, and receive the P-SRS and the A-SRS transmitted by the mobile station apparatus based on the notified parameter sets. Therefore, there has been a problem that overhead during a period from a time when the macro base station apparatus transmits, to the mobile station apparatus, the instruction of connection with the small cell to a time when the pico base station apparatus performs scheduling of the mobile station apparatus.

The present invention has been made in view of the aforementioned points, and provides a base station apparatus which reduces overhead during a period from a time when an instruction of connection with a small cell is given to a time when a pico base station apparatus assigns radio resources to the mobile station apparatus.

### Solution to Problem

(1) The present invention has been made for solving the aforementioned problems, and an aspect of the present invention is a first base station apparatus that constitutes a first cell for transmitting control information to a mobile station apparatus, in which a second cell that is constituted by a second base station apparatus exists in the first cell, the control information with which the first base station apparatus gives an instruction of transmission of a reference signal to the mobile station apparatus in the first cell includes therein information for designating to transmit the reference signal to either the first base station apparatus or the second base station apparatus and information of a transmission parameter that is used for transmission of the reference signal to a base station apparatus that is instructed in the control information, and the first base station apparatus notifies the mobile station apparatus of the control information.

(2) Moreover, an aspect of the present invention is that a cell ID is notified as the information for designating to transmit the reference signal to either the first base station apparatus or the second base station apparatus.

(3) Moreover, an aspect of the present invention is that a carrier frequency is notified as the information for designating to transmit the reference signal to either the first base station apparatus or the second base station apparatus.

(4) Moreover, an aspect of the present invention is that the first base station apparatus notifies the mobile station apparatus in advance of both a parameter of the reference signal that is transmitted to the first base station apparatus and a parameter of the reference signal that is transmitted to the second base station apparatus.

(5) Moreover, an aspect of the present invention is that the first base station apparatus designates the base station apparatus to which the reference signal is to be transmitted depending on a type of the control information for instructing transmission of the reference signal.

### ADVANTAGEOUS EFFECTS OF INVENTION

According to the present invention, it becomes possible to improve the throughput of an entire cell.

### BRIEF DESCRIPTION OF DRAWINGS

FIG. 1 is a schematic view of uplink of a cellular system according to a first embodiment;

FIG. 2 is a sequence diagram of the first embodiment;

FIG. 3 is a schematic block diagram showing one example of a configuration of a macro base station apparatus eNB1 according to the first embodiment;

FIG. 4 is a schematic block diagram showing one example of a configuration of a mobile station apparatus according to the first embodiment;

FIG. 5 is a schematic block diagram showing one example of a configuration of a pico base station apparatus eNB2 according to the first embodiment;

FIG. 6 is a schematic block diagramming one example of a configuration of the macro base station apparatus eNB1 according to a second embodiment;

FIG. 7 is a schematic block diagram showing one example of a configuration of a mobile station apparatus according to the second embodiment;

FIG. 8 is a schematic block diagram showing one example of a configuration of the macro base station apparatus eNB1 according to a third embodiment; and

FIG. 9 is a schematic block diagram showing one example of a configuration of a mobile station apparatus according to the third embodiment.

### DESCRIPTION OF EMBODIMENTS

Description will hereinafter be given for embodiments of the present invention with reference to drawings. In each embodiment below, a transmission apparatus that performs transmission of data or a reference signal is defined as a mobile station apparatus (user equipment; UE), and a reception apparatus which receives data or a reference signal is defined as a base station apparatus (eNB; e-NodeB).

### First Embodiment

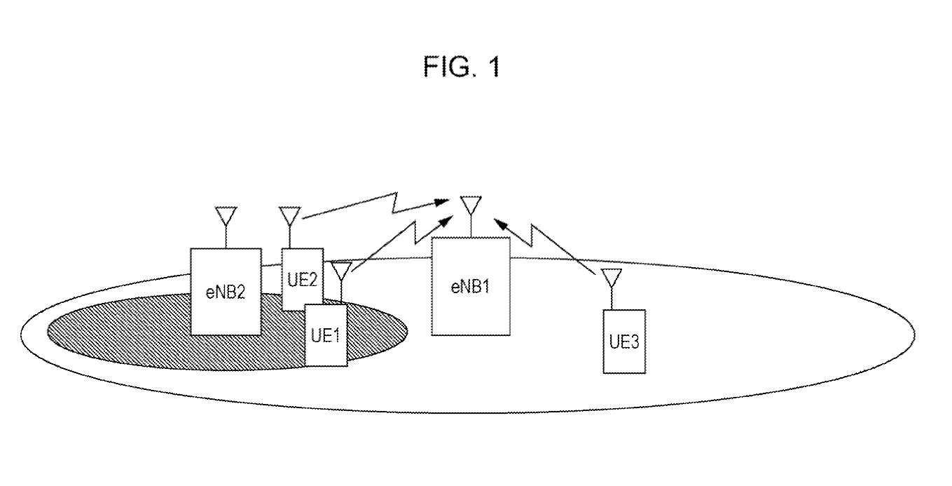

FIG. 1 is a schematic view of uplink of a cellular system according to a first embodiment of the present invention. In the cellular system of FIG. 1, a macro base station apparatus eNB1 having a wide coverage (large cell radius) exists, a pico base station apparatus eNB2 constituting a small cell (shaded region in the figure), which has a small radius, exists in a cell of the macro base station apparatus eNB1, and mobile station apparatuses UE1, UE2 and UE3 which are connected with any of the base station apparatuses exist. Here, the macro base station apparatus eNB1 and the pico base station apparatus eNB2 have different cell IDs. The cell ID may be a physical cell ID (PCID) or a virtual cell ID (VCID). The same figure shows a case where the mobile station apparatuses UE1, UE2 and UE3 are connected with the macro base station apparatus eNB1, in which the macro base station apparatus eNB1 is able to give an instruction of connection with the pico base station apparatus eNB2 to the mobile station apparatuses UE1 and UE2 for the purpose of offloading. In order to determine a mobile station apparatus for offloading, the macro base station apparatus eNB1 is able to give an instruction of A SRS transmission by a parameter set for the pico base station apparatus eNB2 to the mobile station apparatus as a candidate of offloading before the instruction of connection with the pico base station apparatus eNB2. Therefore, the macro base station apparatus eNB1 is able to determine the mobile station apparatus to give the instruction of connection with the pico base station apparatus eNB2 appropriately based on channel performances. Further, it is possible to reduce overhead from a time when the instruction of connection with the pico base station apparatus eNB2 is given to a time when the pico base station apparatus eNB2 performs assignment of radio resources. In this description, only a case where the small cell constituted by the pico base station apparatus eNB2 is included in the cell (macro cell) constituted by the macro base station apparatus eNB1 is described, but the present invention may be applied to a case where a part of the small cell is included in the macro cell and a case where the small cell is not included in the macro cell.

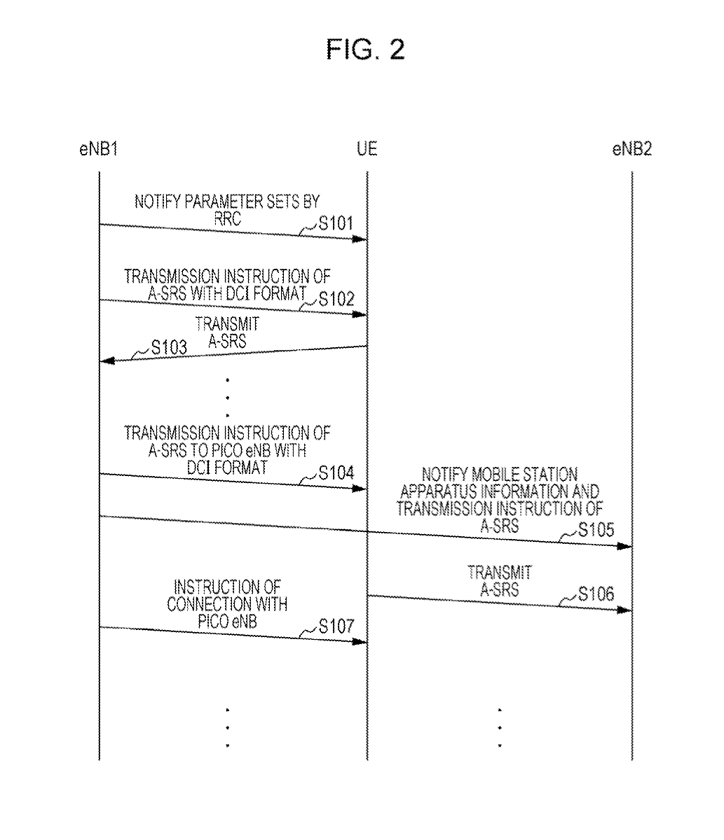

FIG. 2 shows a sequence diagram of the present embodiment. First, at S101, the macro base station apparatus eNB1 notifies the mobile station apparatus which is connected with the macro base station apparatus eNB1 of five types of parameter sets by RRC signaling. At S102, the macro base station apparatus eNB1 notifies the mobile station apparatus of a transmission instruction of the A-SRS with the parameter set for the macro base station apparatus. At S103, the mobile station apparatus transmits the A-SRS based on the parameter set. The macro base station apparatus eNB1 receives, the A-SRS which is transmitted to a plurality of mobile station apparatuses through steps S101 to S103 and grasps channel performances to thereby perform assignment of radio resources of data transmission. In a case of causing a part of the mobile station apparatuses to be connected with the pico base station apparatus eNB2 for the purpose of offloading or the like, the macro base station apparatus eNB1 selects a candidate mobile station apparatus to be connected with the pico base station apparatus eNB2. At S104, the macro base station apparatus eNB1 notifies the selected mobile station apparatus of a transmission instruction of the A-SRS with the parameter set for the pico base station apparatus. Further, at S105, the macro base station apparatus eNB1 notifies the pico base station apparatus eNB2 of information of the mobile station apparatus which transmits the A-SRS to the pico base station apparatus eNB2 and information of the parameter set with which the transmission instruction is given. At. S106, the mobile station apparatus transmits the A-SRS based on the parameter set. At S107, the macro base station apparatus eNB1 notifies the mobile station apparatus of an instruction of connection with the pico base station apparatus eNB2. Here, the connection means data transmission.

In the example of FIG. 2, channel performances which are estimated by the pico base station apparatus eNB2 with the A-SRS transmitted at S106 are not notified to the macro base station apparatus eNB1, but may be notified. Further, the macro base station apparatus eNB1 may be notified by the pico base station apparatus eNB2 of channel performances of a plurality of mobile station apparatuses and select the mobile station apparatus to which the instruction of connection with the pico base station apparatus eNB2 is given from the plurality of mobile station apparatuses. Moreover, in the present example, the instruction of connection with the pico base station apparatus eNB2 at S107 is notified only to the mobile station apparatus, but may be notified to the Pico base station apparatus eNB2 or the mobile station apparatus which has received the instruction of connection with the pico base station apparatus eNB2 may transmit a scheduling request (SR) to the pico base station apparatus eNB2 to thereby notify the pico base station apparatus eNB2 indirectly.

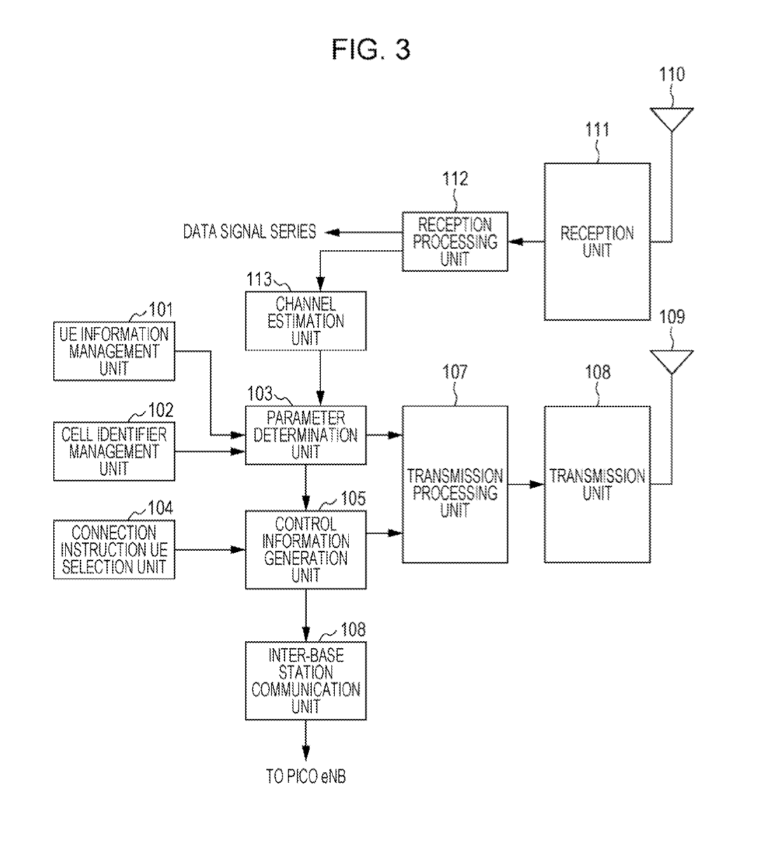

FIG. 3 is a schematic block diagram showing one example of a configuration of the macro base station apparatus eNB1 according to the present embodiment. In the same figure, the macro base station apparatus eNB1 has each one of a transmit antenna and a receive, antenna for simplification of explanation, but may have a plurality of antennas. Moreover, the macro base station apparatus eNB1 may be configured to perform transmission and reception with one antenna. The macro base station apparatus eNB1 stores connecting UE information in a UE information management unit 101, and in a case of giving the instruction of connection with the pico base station apparatus eNB2 to a part of the mobile station apparatuses, outputs the UE information to a parameter determination unit 103. A cell identifier management unit 102 outputs a PCID or a VCID of the pico base station apparatus eNB2 serving as a candidate of a connection destination to the parameter determination unit 103. The parameter determination unit 103, to which channel information of a plurality of mobile station apparatuses is input by a channel estimation unit 113, selects the mobile station apparatus in which the parameter set for the pico base station apparatus is included in a part of the parameter sets of the A-SRS with the channel information and the UE information. The parameter determination unit 103 determines cell ID information in addition to information of a rotation amount of cyclic shift, a position of Comb of IFDM, the number of antenna ports, an SRS transmission bandwidth, and a frequency position, as the parameter sets of the A-SRS for each mobile station apparatus. For example, one example of the cell ID included in five types of the parameter sets is shown in a table 1.

TABLE 1

| Parameter set | Cell ID |
|---|---|
| DCI format 4, pattern 1 | CIDp |
| DCI format 4, pattern 2 | CIDp |
| DCI format 4, pattern 3 | CIDm |
| DCI format 0 | CIDm |
| DCI format 1A/2B/2C | CIDm |

Here, CIDm is the cell ID of the macro base station apparatus eNB1 and CIDp is the cell ID of the pico base station apparatus eNB2. In this example, when the macro base station apparatus eNB1 gives a transmission instruction of the A-SRS with the pattern 1 or 2 of the DCI format 4, the mobile station apparatus which has received the instruction generates a signal of the A-SRS based on the cell ID of the pico base station apparatus eNB2. Moreover, in a case that the macro base station apparatus eNB1 gives the transmission instruction of the A-SRS with the pattern 3 of the DCI format 4 or another DCI format(the mobile station apparatus which has received the instruction generates a signal of the A-SRS based on the cell ID of the macro base station apparatus eNB1.

As an example of parameter sets different from those in the table 1, the cell ID of the macro base station apparatus eNB1 may be used in the patterns 1 to 3 of the DCI format 4 and the cell ID of the pico base station apparatus eNB2 may be used in the other DCI format. In this case, whether a transmission destination of the A-SRS is the macro base station apparatus or the pico base station apparatus is determined depending on the type of the DCI format.

The parameter determination unit 103 outputs information of the determined cell ID, a phase rotation amount between subcarriers of cyclic shift, a position of Comb of IFDM, the number of antenna ports, an SRS transmission bandwidth, and a frequency position, to a control information generation unit 105 and a transmission processing unit 107.

On the other hand, a connection instruction UE selection unit 104 determines the mobile station apparatus as a candidate for giving the instruction of connection with the pico base station apparatus eNB2 to perform output to the control information generation unit 105. The five parameter sets of the A-SRS which are notified to the mobile station apparatus in advance by RRC signaling are input from the parameter determination unit 103 to the control information generation unit 105 and stored therein. The control information generation unit 105, to which information of the mobile station apparatus as the candidate for instructing connection with the pico base station apparatus eNB2 is input from the connection instruction UE selection unit 104, transmits a DCI format which designates the parameter set for the pico base station apparatus when performing the transmission instruction of the A-SRS for the corresponding mobile station apparatus. When the macro base station apparatus eNB1 gives the transmission instruction of the A-SRS to other mobile station apparatus, the macro base station apparatus eNB1 transmits a DCI format which designates the parameter set for the macro base station apparatus. In the example of the table 1, the macro base station apparatus eNB1 notifies a UE which is instructed to transmit the A-SRS with the parameter set for the pico base station apparatus of the instruction with the pattern 1 or 2 of the DCI format 4, and the macro base station apparatus eNB1 notifies a UE which is instructed to transmit the A-SRS with the parameter set for the macro base station apparatus of the instruction with the pattern 3 of the DCI format 4. However, this is one example and the macro base station apparatus eNB1 may perform the notification by using parameter sets of different DCI formats.

In addition to the transmission instruction of the A-SRS, the control information generation unit 105 generates control information data which is transmitted with a physical downlink control channel (PDCCH) by using different control information. In the case of the DCI format 4, information which is included as the different control information includes frequency resource assignment, modulation and coding schemes (MCS), and transmit power control (TPC). The control information generation unit 105 outputs a control .information signal which is generated to the transmission processing unit 107 and an inter-base station communication unit 106. The inter-base station communication unit 106 notifies the pico base station apparatus eNB2 of information of the mobile station apparatus to which the transmission instruction of the A-SRS is given with the parameter set for the pico base station apparatus and the parameter set.

The transmission processing unit 107 multiplexes other information to be notified by RRC signaling, downlink data, PDCCH of control information and the like, and generates a plurality of orthogonal frequency division multiplexing (OFDM) signals to thereby constitute sub-frames, followed by outputting to the transmission unit 108. The transmission unit 108 inserts a cyclic prefix (CP) to the signals which are input and made into the sub-frames. The transmission unit 108 converts the signals to which the CP is inserted into analog signals by digital/analog (D/A) conversion, and up-converts the converted signals to a radio frequency. The transmission unit 108 amplifies the up-converted signals by a PA (Power Amplifier) for transmission through a transmit antenna 109.

The macro base station apparatus eNB1 receives signals in which a reference signal of the A-SRS or the P-SRS and data signals are multiplexed by a receive antenna 110 to input to a reception unit 111. The reception unit 111 down-converts the received signals to a baseband frequency and performs analog/digital (A/D) conversion for the down-converted signals to thereby generate digital signals. Further, the reception unit 111 outputs signals obtained by removing the CP from the digital signals to a reception processing unit 112. The reception processing unit 112 separates data signal series and the reference signal, and outputs the reference signal to the channel estimation unit 113. The channel estimation unit 113 estimates channel performances (frequency response) by the received reference signal to output to the parameter determination unit 103.

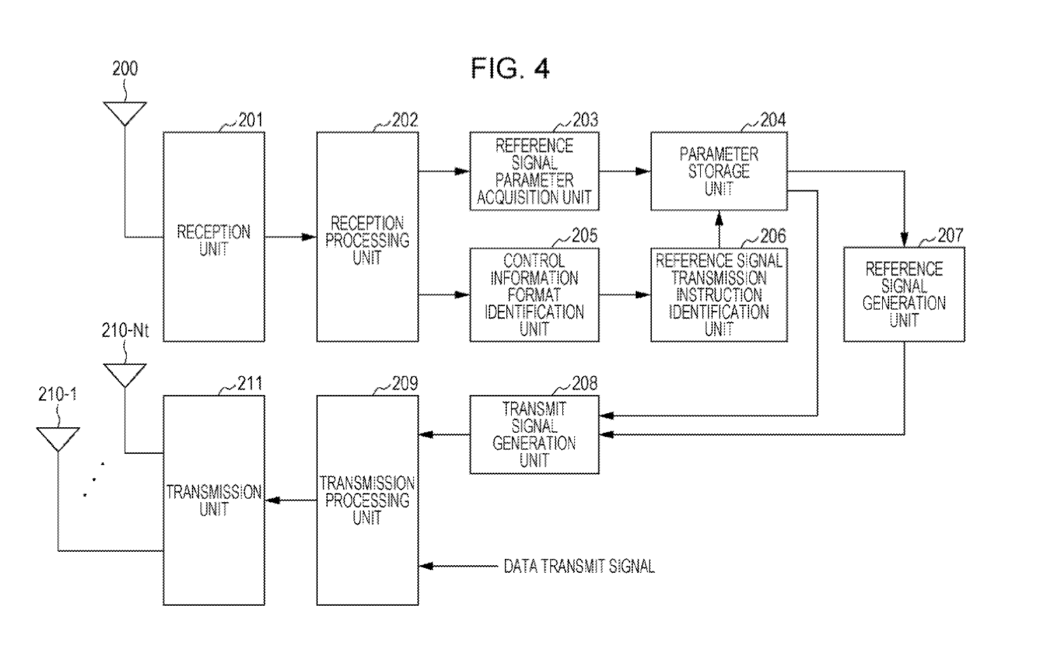

FIG. 4 is a schematic block diagram showing one example of a configuration of a mobile station apparatus according to the present embodiment. In the same figure, one receive antenna is provided, but a plurality of pieces may be provided. The mobile station apparatus receives signals transmitted from the macro base station apparatus eNB1 or the pico base station apparatus eNB2 through a receive antenna 200 to input to a reception unit 201. The reception unit 201 down-converts the received signals to a baseband frequency and performs A/D conversion for the down-converted signals to thereby generate digital signals. The reception unit 201 outputs signals obtained by removing the CP from the digital signals to a reception processing unit 202. The reception processing unit 202 outputs the parameter set of A-SRS notified by RRC signaling from the plurality of OFDM signals which are made into the sub-frames to a reference signal parameter acquisition unit 203, and outputs the DCI format to a control information format identification unit 205. Here, as to the DCI format, a format to be used is determined in advance depending on a transmission mode, and the mobile station apparatus acquires control information by performing blind decoding with a data size of the format to be used for a plurality of candidates of a search space. The reference signal parameter acquisition unit 203 outputs the received parameter set of the A-SRS to a parameter storage unit 204.

The control information format. identification unit 205, to which the DCI format acquired by the blind decoding is input, identifies the format by a data length. However, a part of DCI formats has a same size and for the DCI format, the format is judged with an identification flag of the format. The control information format identification unit 205 outputs the received format and a bit indicating a transmission instruction of the A-SRS to a reference signal transmission instruction identification unit 206.

In a case that the bit indicating the input transmission instruction of the A-SRS is a transmission request of the A-SRS, the reference signal transmission instruction identification unit 206 judges the parameter set to be used from received format information and the bit for the transmission instruction. of the A-SRS and outputs the designated parameter. set and the transmission request. of the A-SRS to the parameter storage unit 204.

The parameter storage unit 204 stores the notified parameter set, and in a case that the parameter set which is designated as the transmission request of the A-SRS by the reference signal transmission instruction identification unit 206 is input, outputs information of the designated parameter set to a reference signal generation unit 207 and a transmit signal generation unit 208. The reference signal generation unit 207 generates a sequence of the reference signal by a cell ID included in the designated parameter to output to the transmit signal generation unit 208. The transmit signal generation unit 208, to which the reference signal is input, generates a transmission reference signal based on information of a rotation amount of cyclic shift, a position of Comb of IFDM, the number of antenna ports, an SRS transmission bandwidth, and a frequency position, which are designated by the parameter storage unit 204, to output to a transmission processing unit 209. The transmission processing unit 209, to which the transmission reference signal and a transmission data signal are input, makes these signals into sub-frames to serve as transmit signals, which are output to a transmission unit 211. The transmission unit 211 inserts CP to the signals which are input and made into the sub-frames to convert into analog signals by D/A conversion, and up-converts the converted signals into a radio frequency. The transmission unit 211 amplifies the up-converted signals by the PA to transmit through transmit antennas 210-1 to 210-Nt. Here, the number of antenna ports is determined based on information of the parameter set to be used.

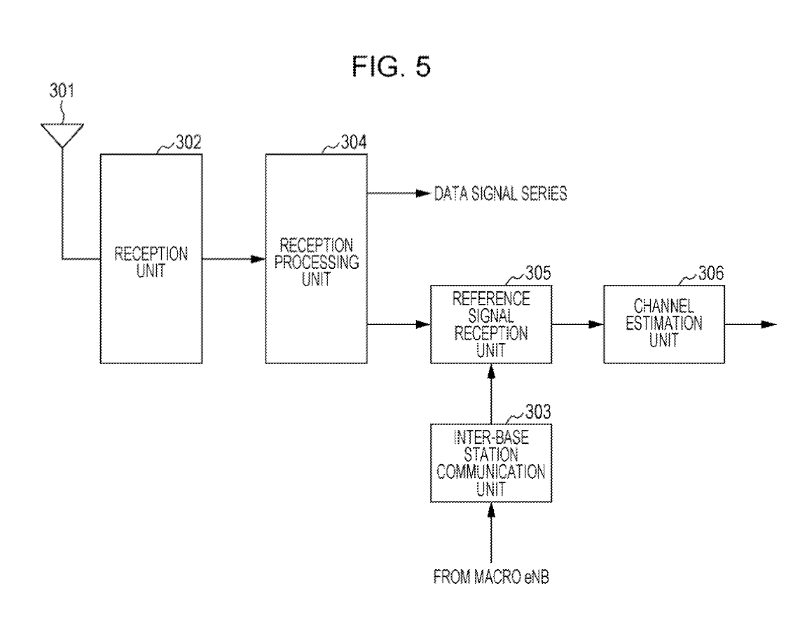

FIG. 5 is a schematic block diagram showing one example of a configuration of the pico base station apparatus eNB2 according to the present embodiment. In the same figure, the number of receive antennas of the pico base station apparatus eNB2 is one, but a plurality of pieces may be provided. In the pico base station apparatus eNB2, information of the mobile station apparatus to which the transmission instruction of the A-SRS with the parameter set for the pico base station apparatus is given by the macro base station apparatus eNB1 and information of the parameter set which is used by the mobile station apparatus are input to an inter-base station communication unit 303. The interbase station communication unit 303 outputs the notified information to a reference signal reception unit 305. The pico base station apparatus eNB2 receives signals transmitted from the mobile station apparatus thorough a receive antenna 301 to output to a reception, unit 302. The reception unit 302 performs same processing as the reception unit 111, and outputs digital signals from which the CP has been removed to a reception processing unit 304. The reception processing unit 304 separates data signal series and a reference signal, and outputs the reference signal to the reference signal reception unit 305. The reference signal reception unit 305 extracts the A-SRS based on the information of the parameter set which is input by the inter-base station communication unit 303 to output to a channel estimation unit 306. The channel estimation unit 306 acquires channel performances by the input A-SRS.

In the present embodiment, an example is shown that when the macro base station apparatus eNB1 gives the transmission instruction of the A-SRS with the parameter set for the pico base station apparatus, information of the parameter set is notified to the pico base station apparatus eNB2, but the parameter set for the pico base station apparatus may be notified in advance.

As above, the mobile station apparatus which is connected with the macro base station apparatus eNB1 becomes possible to transmit the A-SRS to the pico base station apparatus eNB2, and the pico base station apparatus eNB2 is able to grasp channel performances of the mobile station apparatus as a candidate for giving a connection instruction. It is therefore possible to give the instruction of connection with the pico base station apparatus eNB2 to the mobile station apparatus having excellent channel performances between the mobile station apparatus and the pico base station apparatus. Further, since the pico base station apparatus eNB2 is able to grasp the channel performances before the instruction of connection with the pico base station apparatus eNB2, it is possible to reduce overhead from a time when the instruction of connection with the pico base station apparatus eNB2 is given to a time when the pico base station apparatus eNB2 performs assignment of radio resources.

### Second Embodiment

In the present embodiment 1 description will be given for a case where the macro base station apparatus eNB1 and the pico base station apparatus eNB2 have the same cell ID and use different carrier frequencies. An example thereof includes a case where the macro base station apparatus eNB1 uses a 2 GHz band and the pico base station apparatus eNB2 uses a 3.5 GHz band.

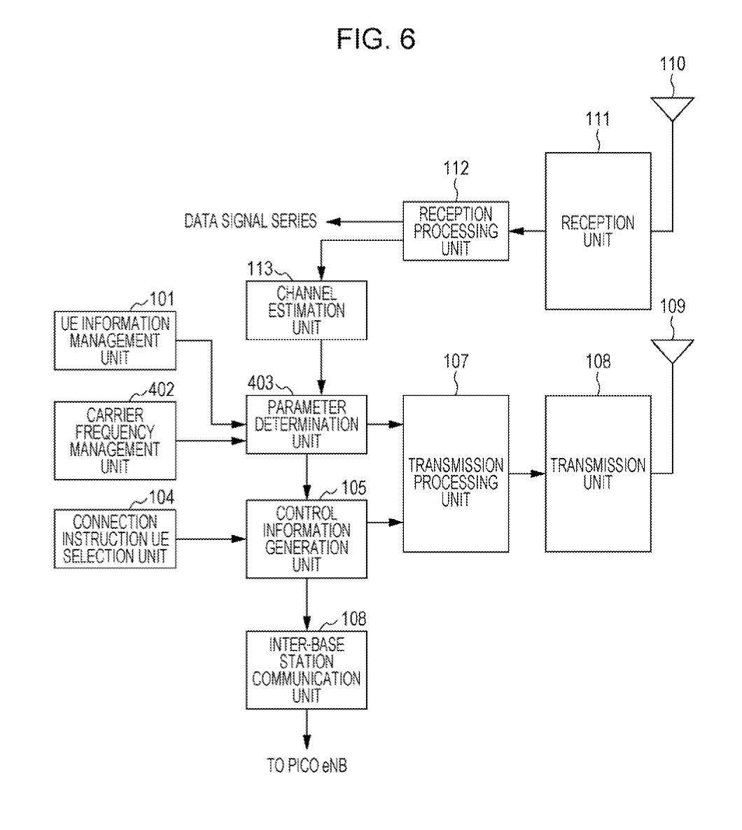

Since a sequence diagram of the present embodiment is the same as that of the previous embodiment and becomes as shown in FIG. 2, description thereof will be omitted. A schematic block diagram showing one example of a configuration of the macro base station apparatus eNB1 according to the present embodiment is shown in FIG. 6. Compared to FIG. 3, the cell identifier management unit 102 serves as a carrier frequency management unit 402 and the parameter determination unit 103 serves as a parameter determination unit 403. Other configurations are the same and description regarding processing same as that of the previous embodiment will be omitted. The carrier frequency management unit 402 holds information of the carrier frequency which is used by the pico base station apparatus eNB2 serving as a candidate of a connection destination, and outputs this information to the parameter determination unit 403. The parameter determination unit 403, to which channel information of a plurality of mobile station apparatuses are input, by the channel estimation unit 113, selects the mobile station apparatus in which the parameter set for the pico base station apparatus is included in a part of the parameter sets of the A-SRS with the channel information and UE information. The parameter determination unit 403 determines information of the carrier frequency in addition to information of a rotation amount of cyclic shift, a position of Comb of IFDM, the number of antenna ports, an SRS transmission bandwidth, and a frequency position, as the parameter sets of the A-SRS for each mobile station apparatus. For example, one example of the information of the carrier frequency included in five types of the parameter sets is shown in a table 2.

TABLE 2

| Parameter set | Carrier frequency |
|---|---|
| DCI format 4, pattern 1 | F2 |
| DCI format 4, pattern 2 | F1 |
| DCI format 4, pattern 3 | F1 |
| DCI format 0 | F1 |
| DCI format 1A/2B/2C | F1 |

Here, F1 is the carrier frequency of the macro base station apparatus eNB1 and F2 is the carrier frequency of the pico base station apparatus eNB2. In this example, when the macro base station apparatus eNB1 gives a transmission instruction of the A-SRS with the pattern 1 of the DCI format 4, the mobile station apparatus transmits signals of the A-SRS with the carrier frequency of the pico base station apparatus eNB2. Moreover, when the macro base station apparatus eNB1 gives the transmission instruction of the A-SRS with the pattern 2 or 3 of the DCI format 4 or another DCI format, the mobile station apparatus transmits signals of the A-SRS with the carrier frequency of the macro base station apparatus eNB1.

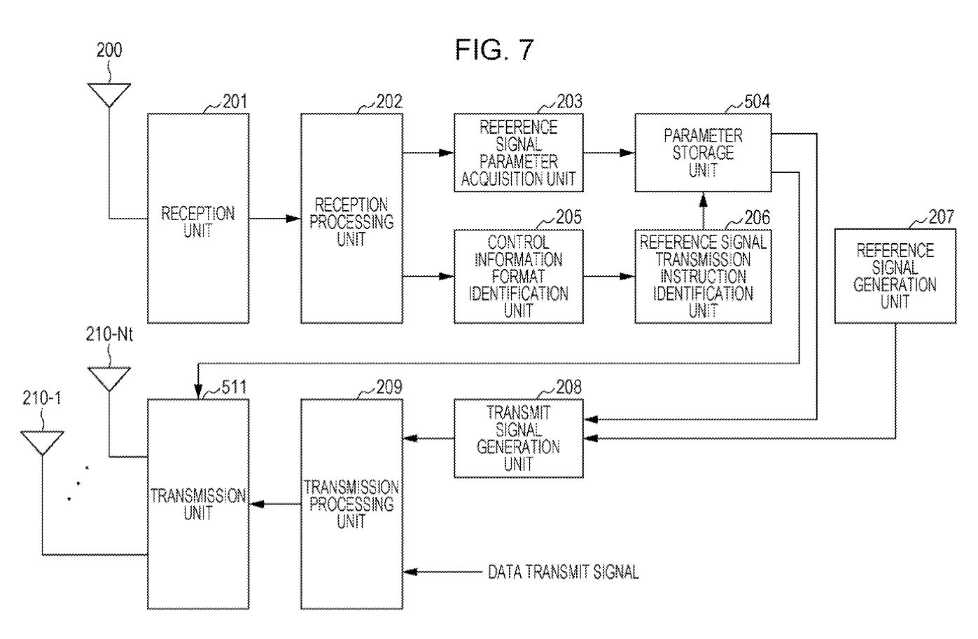

FIG. 7 is a schematic block diagram showing one example of a configuration of a mobile station apparatus according to the present embodiment. Compared to FIG. 4, FIG. 7 is different in terms of a parameter storage unit 504 and a transmission unit 511. Other configurations are the same and description regarding processing same as that of the previous embodiment will be omitted. The parameter storage unit 504 stores the parameter set which is notified, and when the parameter set which is designated as a transmission request of the A-SRS by the reference signal transmission instruction identification unit 206 is input, outputs information of the carrier frequency included in the designated parameter set to the transmission unit 511 and outputs information of other parameter sets to the transmit signal generation unit 208. The transmission unit 511 inserts CP to signals which are made into sub-frames to convert into analog signals by D/A conversion for up-converting with the input information of the carrier frequency. The transmission unit 511 amplifies the up-converted signals by the PA to transmit through the transmit antennas 210-1 to 210-Nt. Here, the number of antenna ports is determined based on information of the parameter set to be used

Since a configuration of the pico base station apparatus eNB2 according to the present embodiment is the same as that of the previous embodiment and becomes as shown in FIG. 5, description thereof will be omitted.

As above, the mobile station apparatus which is connected with the macro base station apparatus eNB1 becomes possible to transmit the A-SRS to the pico base station apparatus eNB 2, and the pico base station apparatus eNB2 is able to grasp channel performances of the mobile station apparatus as a candidate for giving a connection instruction. It is therefore possible that the macro base station apparatus eNB1 gives the instruction of connection with the pico base station apparatus eNB2 to the mobile station apparatus having excellent channel performances between the mobile station apparatus and the pico base station apparatus. Further, since it is possible to grasp the channel performances before the instruction of connection with the pico base station apparatus eNB2, it is possible to reduce overhead from a time when the instruction of connection with the pico base station apparatus eNB2 is given to a time when the pico base station apparatus eNB2 performs assignment of radio resources.

### Third Embodiment

In the present embodiment, description will be given for a case where both cell IDs and carrier frequencies to be used are different between the macro base station apparatus eNB1 and the pico base station apparatus eNB2.

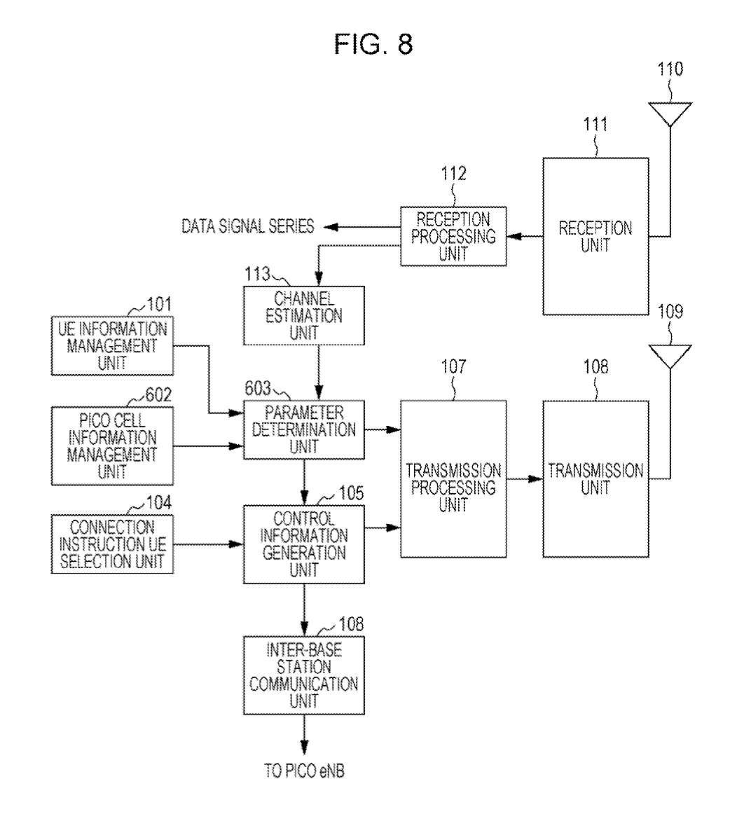

Since a sequence diagram of the present embodiment is the same as that of the previous embodiment and becomes as shown in FIG. 2, description thereof will be omitted. A schematic block diagram showing one example of a configuration of the macro base station apparatus eNB1 according to the present embodiment is shown in FIG. 8. Compared to FIG. 6, the carrier frequency management unit 402 serves as a pico cell information management unit 602 and the parameter determination unit 403 serves as a parameter determination unit 603. Other configurations are the same and description regarding processing same as that of the previous embodiment will be omitted. The pico cell information management unit 602 holds information of the carrier frequency which is used by the pico base station apparatus eNB2 serving as a candidate of a connection destination, and either the PCID or the VCID, and outputs this information to the parameter determination unit 603. The parameter determination unit 603, to which channel information of a plurality of mobile station apparatuses are input by the channel estimation unit 113, selects the mobile station apparatus in which the parameter set for the pico base station apparatus is included in a part of the parameter sets of the A-SRS with the channel information and UE information. The parameter determination unit 603 determines information of the cell ID and the carrier frequency in addition to information of a rotation amount of cyclic shift, a position of Comb of IFDM, the number of antenna ports, an SRS transmission bandwidth, and a frequency position, as the parameter sets of the A-SRS for each mobile station apparatus. For example, one example of the information of the carrier frequency included in five types of the parameter sets is shown in a table 3.

TABLE 3

| Parameter set | Carrier frequency | Cell ID |
|---|---|---|
| DCI format 4, pattern 1 | F2 | CIDp |
| DCI format 4, pattern 2 | F1 | CIDm |
| DCI format 4, pattern 3 | F1 | CIDm |
| DCI format 0 | F1 | CIDm |
| DCI format 1A/2B/2C | F1 | CIDm |

Here, F1 is the carrier frequency of the macro base station apparatus eNB1 and F2 is the carrier frequency of the pico base station apparatus eNB2. Moreover, CIDm is the cell ID of the macro base station apparatus eNB1 and CIDp the cell ID of the pico base station apparatus eNB2. In this example, when giving a transmission instruction of the A-SRS with the pattern 1 of the DCI format 4, the mobile station apparatus transmits a signal of the A-SRS with the parameter set for the pico base station apparatus. Moreover, when giving the transmission instruction of the A-SRS with the pattern 2 or 3 of the DCI format 4 or another DCI format, the mobile station apparatus transmits the signal of the A-SRS with with the parameter set for the macro base station apparatus.

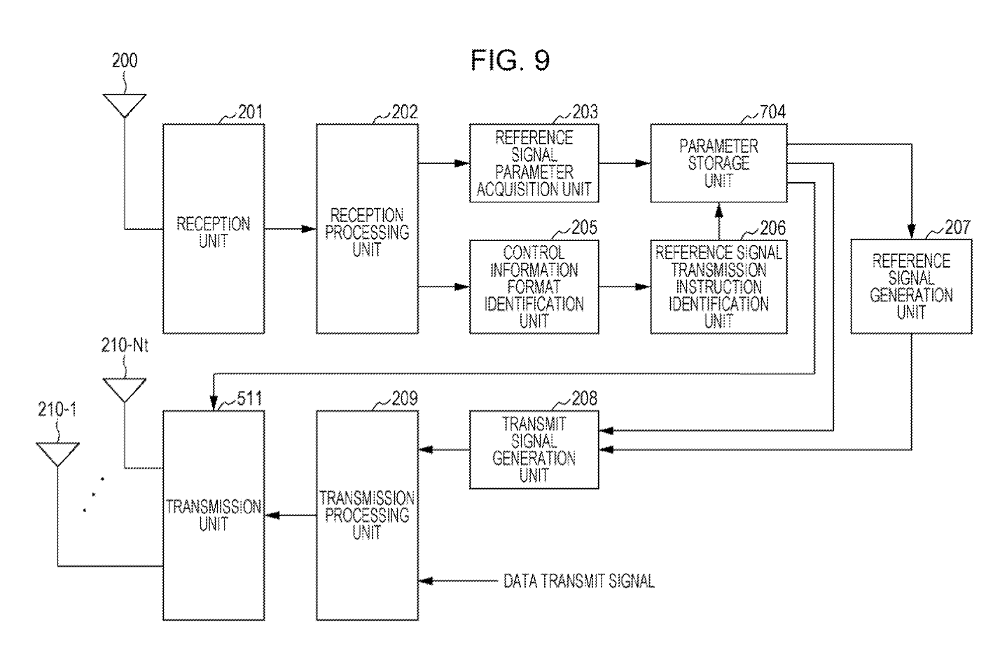

FIG. 9 is a schematic block diagram showing one example of a configuration of a mobile station apparatus according to the present embodiment. Compared to FIG. 7, FIG. 9 is different only in terms of a parameter storage unit 704. Other configurations are the same and description regarding processing same as that of the previous embodiment will be omitted. The parameter storage unit 704 stores the parameter set which is notified, and when the parameter set which is designated as a transmission request of the A-SRS by the reference signal transmission instruction identification unit 206 is input, outputs information of the carrier frequency included in the designated parameter set to the transmission unit 511, outputs information of the cell ID to the reference signal generation unit 207, and outputs information of other parameter sets to the transmit signal generation unit 208. Since other processing is the same as that of the previous embodiment, description thereof will be omitted.

Since a configuration of the pico base station apparatus eNB2 according to the present embodiment is the same as that of the previous embodiment and becomes as shown in FIG. 5, description thereof will be omitted.

In the embodiments 1 to 3, a method for determining the base station apparatus to which the A-SRS is to be transmitted with information indicating the format of the PDCCH or the parameter sets of the A-SRS included in the format of the POOCH is shown. In the present invention, the macro base station apparatus may designate the method for determining the base station apparatus to which the A-SRS is to be transmitted depending on a method for notifying control information, and may perform the designation by notifying the transmission instruction of the A-SRS by enhanced PDCCH (E-PDCCH) or by notifying the transmission instruction of the A-SRS by PDCCH. Specifically, when the transmission instruction of the A-SRS is given by the PDCCH, the mobile station apparatus is instructed to transmit the A-SRS to the pico base station apparatus, and when the transmission instruction of the A-SRS is given by the E-PDCCH, the mobile station apparatus is instructed to transmit the A-SRS to the macro base station apparatus. Thereby, to the mobile station apparatus which supports the E-PDCCH, the macro base station apparatus is able to give the transmission instruction of the A-SRS to the small cell, and the mobile station apparatus which does not support the E-PDCCH, for example, such as the mobile station apparatus of Rel. 10 becomes possible to give the transmission instruction of the A-SRS to the macro base station apparatus as conventionally, so that control in view of backward compatibility becomes possible.

As above, the mobile station apparatus which is connected with the macro base station apparatus eNB1 becomes possible to transmit the A-SRS to the pico base station apparatus eNB2, and the pico, base station apparatus eNB2 is able to grasp channel performances of the mobile station apparatus as a candidate for giving a connection instruction. It is therefore possible that the macro base station apparatus eNB1 gives the instruction of connection with the pico base station apparatus eNB2 to the mobile station apparatus having excellent channel performances between the mobile station apparatus and the pico base station apparatus. Further, since it is possible to grasp the channel performances before the instruction of connection with the pico base station apparatus eNB2, it is possible to reduce overhead from a time when the instruction of connection with the pico base station apparatus eNB2 is given to a time when the pico base station apparatus eNB2 performs assignment of radio resources.

Note that a part of the macro base station apparatus eNB1, the pico base station apparatus eNB2 and the mobile station apparatuses UE according to the aforementioned embodiments may be realized by a computer. In this case, it may be realized by recording a program for realizing control functions thereof in a computer readable recording medium and causing a computer system to read the program recorded in this recording medium for execution. Note that the “computer system” which is referred to here is a computer system incorporated in the macro base station apparatus eNB1, the pico base station apparatus eNB2 or the mobile station apparatuses UE, and includes an OS and hardware such as peripheral equipment. Further, the “computer readable recording medium” refers to a portable medium such as a flexible disk, a magneto-optical disk, a ROM or a CD-ROM, or a storage device such as a hard disk incorporated in the computer system. Furthermore, the “computer readable recording medium” also includes one for holding a program dynamically for a short time period like a communication line when a program is transmitted via a network such as the Internet or a communication line such as a telephone line, and one for holding a program for a fixed period of time like a volatile memory inside a computer system serving as a server or a client in such a case. In addition, the aforementioned program may be for realizing a part of the functions described above, and further may be one capable of realizing the functions described above in combination with a program which has been already recorded in the computer system.

Moreover, a part of or all of the macro base station apparatus eNB1, the pico base station apparatus eNB2 and the mobile station apparatuses UE according to the aforementioned embodiments may be realized as an integrated circuit such as a large scale integration (LSI). Each functional block of the macro base station apparatus eNB1, the pico base station apparatus eNB2 and the mobile station apparatuses Us may be made into a processor individually, or a part or all thereof may be made into a processor being integrated. Further, a method for making into an integrated circuit is not limited to the LSI and a dedicated circuit or a versatile processor may be used for realization. Further, when a technology for making into an integrated circuit in place of the LSI appears with advance of a semiconductor technology, an integrated circuit by this technology may be used.

As above, the embodiments of this invention have been described in detail with reference to drawings, but specific configurations are riot limited to the above, and various design change and the like which are not departed from the gist of this invention are also possible.

### REFERENCE SIGNS LIST

eNB1 macro base station apparatus
eNB2 pico base station apparatus
UE1 to UE3 mobile station apparatus
101 UE information management unit
102 cell identifier management unit
103 parameter determination unit
104 connection instruction UE selection unit
105 control information generation unit
106 inter-base station communication unit
107 transmission processing unit
106 transmission unit
109 transmit antenna
110 receive antenna
111 reception unit
112 reception processing unit
113 channel estimation unit
200 receive antenna
201 reception unit
202 reception processing unit
203 reference signal parameter acquisition unit
204 parameter storage unit
205 control information format identification unit
206 reference signal transmission instruction identification unit
207 reference signal generation unit
208 transmit signal generation unit
209 transmission processing unit
211 transmission unit
210-1 to 210-Nt transmit antenna
301 receive antenna
302 reception unit
303 inter-base station communication unit
304 reception processing unit
305 reference signal reception unit
306 channel estimation unit
402 carrier frequency management unit
403 parameter determination unit
504 parameter storage unit
511 transmission unit
602 pico cell information management unit
603 parameter determination unit
704 parameter storage unit

1. A first base station apparatus that constitutes a first cell for transmitting control information to a mobile station apparatus, wherein a second cell that is constituted by a second base station apparatus exists in the first cell, the control information with which the first base station apparatus gives an instruction of transmission of a reference signal to the mobile station apparatus in the first cell includes therein information for designating to transmit the reference signal to either the first base station apparatus or the second base station apparatus and information of a transmission parameter that is used for transmission of the reference signal to a base station apparatus that is instructed in the control information, and the first base station apparatus notifies the mobile station apparatus of the control information.

2. The first base station apparatus according to claim 1, wherein the information for designating to transmit the reference signal to either the first base station apparatus or the second base station apparatus is a cell ID.

3. The first base station apparatus according to claim 1, wherein the information for designating to transmit the reference signal to either the first base station apparatus or the second base station apparatus is a carrier frequency.

4. The first base station apparatus according to claim 1, wherein the first base station apparatus notifies the mobile station apparatus in advance of both a parameter of the reference signal that is transmitted to the first base station apparatus and a parameter of the reference signal that is transmitted to the second base station apparatus.

5. The first base station apparatus according to claim 4, wherein the first base station apparatus designates the base station apparatus to which the reference signal is to be transmitted depending on a to of the control information for instructing transmission of the reference signal.
